(19) United States
(12) Patent Application Publication
(10) Pub. No.: US 2015/0212986 A1
(43) Pub. Date: Jul. 30, 2015

(54) PREVENTING WEBSITE CONTENT PLAGIARISM AND INDEXING USING A CHARACTER AND FONT GLYPH MAPPING SCHEME

(71) Applicant: Go Daddy Operating Company, LLC, Scottsdale, AZ (US)

(72) Inventor: Jared Lera, San Jose, CA (US)

(73) Assignee: Go Daddy Operating Company, LLC, Scottsdale, AZ (US)

(21) Appl. No.: 14/166,295

(22) Filed: Jan. 28, 2014

(51) Int. Cl. G06F 17/22; G06F 21/10

(52) U.S. Cl. CPC G06F 17/2247; G06F 21/10

(57) ABSTRACT

The invention uses alternate mapping between characters and font glyphs to prevent website content from being plagiarized or indexed by a third party. Specifically, a font glyph file may be created comprising a plurality of font glyphs. One or more font glyphs in the file may illustrate a first character while being mapped to a second character. An altered text file may be created by replacing each character in an original text file with a character that is mapped to a font glyph that illustrates the original character. The server may transmit the altered text file and the font glyph file to a browser. The browser may create an image by replacing each character, in the altered text file, with a font glyph mapped to the character from the font glyph file. The browser may display to a user the image which matches the original text file without the browser ever receiving the original text file.

### FIELD OF THE INVENTION

The present invention generally relates to the field of designing websites and, more particularly, to the field of preventing website content from being plagiarized or indexed by a third party by using an alternate text file and a font glyph file created using an alternate mapping scheme.

### SUMMARY OF THE INVENTION

The present invention provides systems and methods for preventing a website's content from being plagiarized or indexed by using an alternate mapping system between font glyphs and their corresponding mapped characters. A system for practicing the invention may include a website and a storage medium running one or more servers.

The website may be accessible over the Internet to anybody running a browser on their client computer. The website may also access the storage medium for files and/or other data.

The storage medium may store an original text file, an altered text file, and a font glyph file. The original text file may include one or more characters that are desired to be displayed as part of the website. To make it more difficult to plagiarize the text content of the website, the original text file is preferably not sent to browsers viewing the website.

The altered text file may be created from the original text file by replacing one or more (preferably all) characters in the original text file with an alternate character. For example, each “a” in the original file could be replaced with a “b”, and so on, so that the end result is that the text in the altered text file is not the same as the text in the original text file. This allows the altered text file, and not the original text file, to be sent to browsers viewing the website making it more difficult to plagiarize the original text file.

The font glyph file may comprise a plurality of font glyphs. Each font glyph may include graphical data that, when displayed by a browser, illustrates a character. One or more (preferably all) of the font glyphs may be mapped to a different character than the character the font glyph actually illustrates. For example, a font glyph that illustrates an “a” may be mapped to a “b”. This altered mapping may be continued for one or more (preferably all) font glyphs in the font glyph file.

The mapping of the altered text file preferably complements the mapping of the font glyph file, such that when each character in the altered text file is replaced with a font glyph mapped to that character (but possibly illustrating a different character), the text from the original text file may be graphically displayed.

The altered text file and the font glyph file may be transmitted over the Internet to the browser running on the client computer. The browser may create a graphical image of the original text file by replacing each character in the altered text file with a font glyph mapped to the character, where the font glyph may graphical display a different character than the character mapped to the font glyph. In this way, the browser may display a graphical image of the original text file, that matches character for character, without the browser ever receiving the original text file. Not sending the original text file to the browser makes it more difficult to plagiarize the content of the website.

The above features and advantages of the present invention will be better understood from the following detailed description taken in conjunction with the accompanying drawings.

### BRIEF DESCRIPTION OF THE DRAWINGS

FIG. 1 is a block diagram of a system that represents an initial starting condition for practicing the present invention.

FIG. 2 is a block diagram of the system in FIG. 1 after an altered text file and a font glyph file have been transferred from a server to a client computer during the course of practicing the invention.

FIG. 3 is a block diagram of the system in FIG. 2 after a browser has created a graphical image, from the altered text file and the font glyph file, to display to a user.

FIG. 4 illustrates an example of an original text file.

FIG. 5 illustrates an example of a mapping scheme that may be used to turn: 1) the original text file into the altered text file, and then 2) the altered text file and the font glyph file into a graphical image to be displayed on a browser.

FIG. 6 illustrates an example altered text file, created from the original text file in FIG. 4 and the mapping scheme in FIG. 5.

FIG. 7 illustrates an example font glyph file that may be used to convert the altered text file in FIG. 6 into a graphical image, wherein the graphical image displays, in graphical form, the characters in the original text file.

FIG. 8 illustrates an example of a client computer, running a browser, that may receive the altered text file from FIG. 6 and the font glyph file from FIG. 7 and then create and display an image, wherein the image matches the original text file in FIG. 4.

FIG. 9 illustrates a flow diagram of the server(s) in FIGS. 1-3 performing an example method for practicing the invention.

FIG. 10 illustrates a flow diagram of the client computer in FIGS. 1-3 performing an example method for practicing the invention.

FIG. 11 illustrates sample text as it might appear on a website.

FIG. 12 illustrates what the sample text in FIG. 11 might appear as when it is an altered text file.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

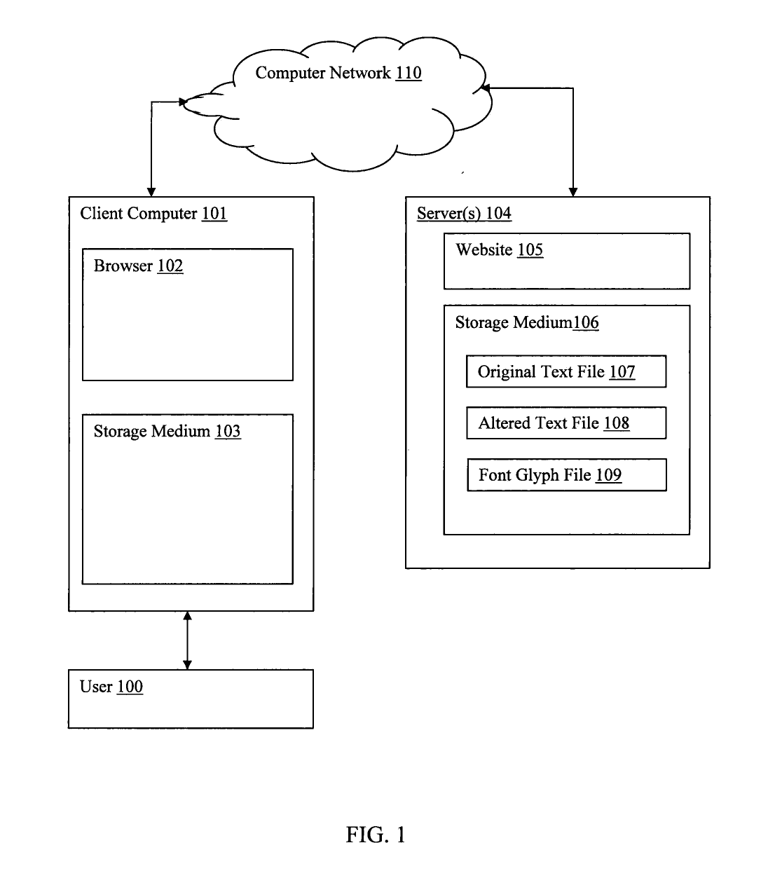

FIG. 1 is a block diagram of a system that may be used to practice the present invention. A computer network 110 may be a collection of links and nodes (e.g., multiple computers and/or other devices connected together) arranged so that information may be passed from one part of the computer network 110 to another part of the computer network 110. Examples of computer networks 102 include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between websites 105 on servers 104 and users 100 on client computers 101. Hundreds of millions of people around the world have access to client computers 101 connected to the Internet via Internet Service Providers (ISPs).

Content providers place multimedia information (e.g., text, graphics, audio, video, animation, and other forms of data) at specific locations on the Internet referred to as websites 105. The combination of all the websites 105 and their corresponding web pages on the Internet is generally known as the World Wide Web (WWW) or simply the Web.

For Internet users 100 and businesses alike, the Internet continues to be increasingly valuable. More people use the Web for everyday tasks, from social networking, shopping, banking, and paying bills to consuming media and entertainment than ever before. E-commerce is growing, with businesses delivering more services and content across the Internet, communicating and collaborating online, and inventing new ways to connect with each other.

Prevalent on the Internet are multimedia websites 105, some of which may offer and sell goods and services to individuals and organizations. Websites 105 may consist of a single webpage, but typically consist of multiple interconnected and related webpages. Websites 105, unless very large and complex or have unusual traffic demands, typically reside on a single server 104 and are prepared and maintained by a single individual or entity (although websites 105 residing on multiple servers 104 is certainly possible and even necessary in some cases). Menus, links, tabs, etc. may be used to move between different web pages within the website 105 or to move to an entirely different website.

Websites 105 may be created using HyperText Markup Language (HTML) to generate a standard set of tags that define how the webpages for the website 105 are to be displayed. Users 100 of the Internet may access content providers' websites 105 using software known as an Internet browser 102, such as MICROSOFT INTERNET EXPLORER, MOZILLA FIREFOX, or GOOGLE CHROME. After the browser 102 has located the desired webpage, it requests and receives information from the webpage, typically in the form of an HTML document, and then displays the webpage content for the user 100 on the client computer 101 using the browser 102. The user 100 may then view other webpages at the same website 105 or move to an entirely different website using the browser 102.

Internet browsers 102 are able to display custom fonts by receiving a text file and a font glyph file. Each character in the text file is replaced by a font glyph for that character. Thus, an “a” in the text file may be displayed by the browser with any desired font or graphical image mapped to the “a” in the font glyph file to thereby create an image to be displayed. For purposes of this invention, specification, and claims, the word “character” should be interpreted broadly and to include at least letters, numbers, and symbols.

Some website 105 owners, typically those that are larger and more sophisticated, may provide their own server(s) 104, software, and connections to the Internet. But many website 105 owners either do not have the resources available or do not want to create and maintain the infrastructure necessary to host their own websites 105. To assist such individuals (or entities), hosting companies exist that offer website hosting services. These hosting providers typically provide the servers 104, software, and electronic communications necessary to connect multiple websites 105 to the Internet. A single hosting provider may literally host thousands of websites on one or more hosting servers 104.

Browsers 102 are able to locate specific websites 105 because each website 105, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. The browser 102 is able to access a website 105 on the Internet through the use of a URL. The URL may include a Hypertext Transfer Protocol (HTTP) request combined with the website's 105 Internet address, also known as the website's 105 domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the Registry is also the authoritative source for contact information related to the domain name and is referred to as a “thick” Registry. For other TLDs (e.g., .com and .net) only the domain name, registrar identification, and name server information is stored within the Registry, and a Registrar is the authoritative source for the contact information related to the domain name. Such Registries are referred to as “thin” registries. Most gTLDs are organized through a central domain name Shared Registration System (SRS) based on their TLD.

The user 100 may use a client computer 101, such as, as non-limiting examples, a cell phone, PDA, tablet, laptop computer, or desktop computer to access a website 105 via the computer network 110, such as the Internet. The client computer 101 may also have a storage medium 103 for storing applications and files from server(s) 104 hosting websites 105. The storage medium 103 may be any type of known or later developed data storage means, such as, as non-limiting examples, RAM, ROM, tapes, floppy, CD, DVD, HD, Blu-ray, flash, bubble, cloud, and/or hard disk drives.

The website 105 may have one or more webpages and be hosted or operated from a server(s) 104. The server(s) 104 include at least one hardware server 104 and may also include, as a non-limiting example, one or more Dell PowerEdge(s) rack server(s), although other types of hardware servers, combinations of one or more servers, server software and applications may also be used.

A storage medium 106, run on the server(s) 104, may be used to practice the invention. The storage medium 106 may store one or more database and/or files. A database is an organized collection of data. The data are typically organized to model relevant aspects of reality in a way that supports processes requiring this information. Database management systems (DBMSs) are specially designed applications that interact with the website 105, other applications, and the database itself to capture and analyze data. A general-purpose database management system (DBMS) is a software system designed to allow the definition, creation, querying, update, and administration of databases. As non-limiting examples, DBMSs may include MySQL, MariaDB, PostgreSQL, SQLite, Microsoft SQL Server, Oracle, SAP, dBASE, FoxPro, IBM DB2, LibreOffice Base and FileMaker Pro.

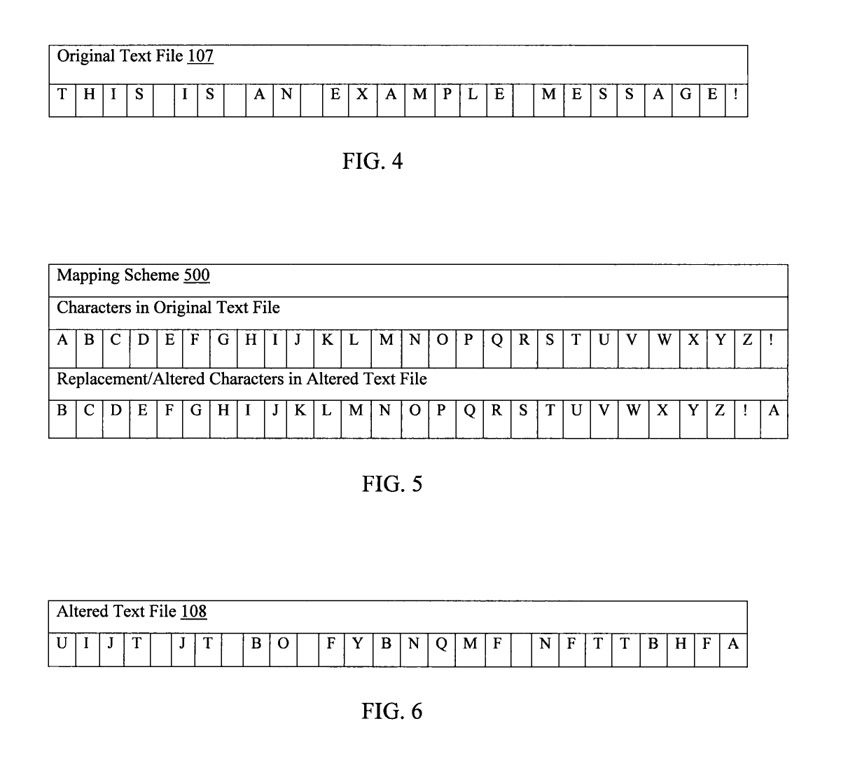

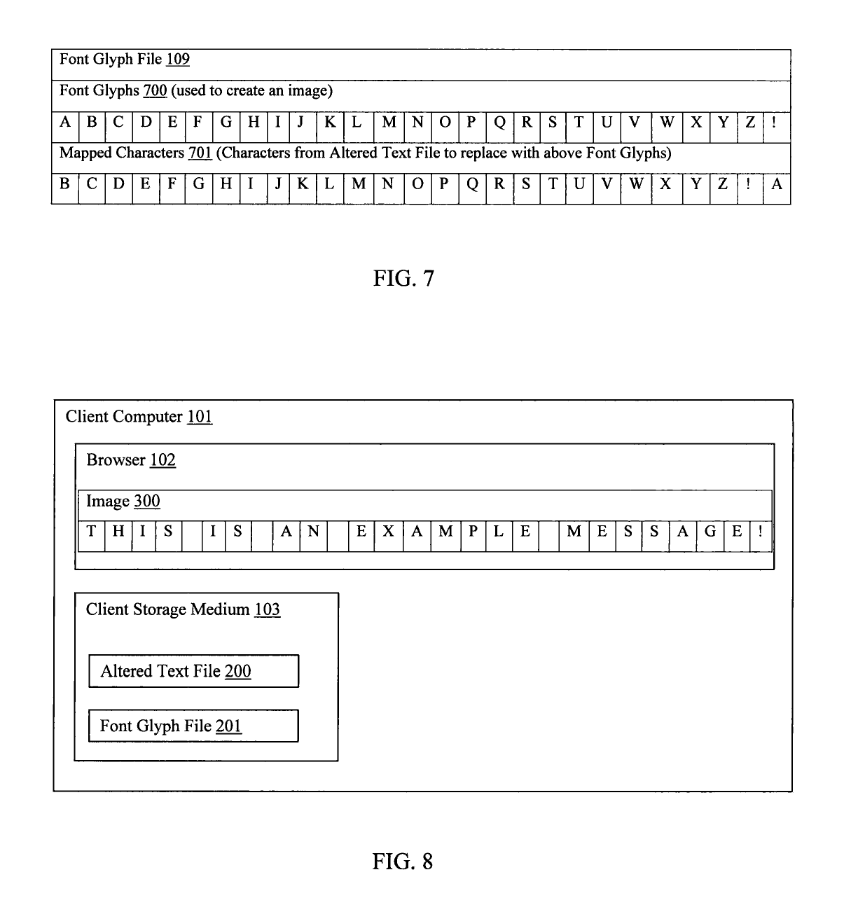

Any type of storage medium 106 on the server(s) 104 may be used to practice the current invention, but the storage medium 106 is preferably able to store at least an original text file 107, an altered text file 108, and a font glyph file 109. An example original text file is illustrated in FIG. 4, an example altered text file is illustrated in FIG. 6, and an example font glyph file 109 is illustrated in FIG. 7.

The original text file 107 may include a string of one or more characters that are to be displayed, on one or more browsers 102, as part of the website 105. To make it more difficult to plagiarize the text content of the website 105, the original text file 107 is preferably not sent to browsers 102 viewing the website 105.

The altered text file 108 may be created from the original text file 107 by replacing one or more (preferably all) characters in the original text file 107 with an alternate character. For example, every “a” in the original file could be replaced with a “b”, every “b” in the original file could be replaced with a “c”, and so on until all the characters in the original text file have been replaced, thereby creating the altered text file 108.

The original text file 107 in FIG. 4 contains the characters “THIS IS AN EXAMPLE MESSSAGE!” Using the mapping scheme 500 shown in FIG. 5, the first letter “T” is replaced with “U”, the second letter “H” is replaced with “I” and so on until one or more, or preferably all of the characters have been replaced/altered according to the mapping scheme 500. In this example, after all of the characters in the original text file 107 have been replaced according to the mapping scheme 500, the altered text file 108, shown in FIG. 6, is “UIJT JT BO FYBNQMF NFTTBHFA”.

The mapping scheme 500 shown in FIG. 5 is but one non-limiting example, and other types of mapping schemes (such as character replacement or encryption), now known or later developed, may also be used to create the altered text file 108 from the original text file 107. The end result is preferably that the text in the altered text file 108 is not the same as the text in the original text file 107. This allows the altered text file 108, and not the original text file 107, to be sent to browsers 102 viewing the website 105, thereby making it more difficult to plagiarize the original text file 107.

As shown in FIG. 7, the font glyph file 109 may comprise a plurality of font glyphs 700. Each font glyph 700 may include graphical data that, when displayed by a browser, illustrates a character. One or more (preferably all) of the font glyphs may be mapped to a different character (mapped character 701) than the character the font glyph actually illustrates. For example, as shown in FIG. 7, a font glyph that illustrates an “A” may be mapped to a “B”, “B” may be mapped to “C”, and so on. This altered mapping may be continued for one or more (preferably all) font glyphs 700 in the font glyph file 109. In the example illustrated in FIGS. 4-7, the character for a space is mapped to a space demonstrating that not all characters have to be mapped to different characters.

The mapping of the altered text file 108 preferably complements the mapping of the font glyph file 109, such that when each character in the altered text file 108 is replaced with a font glyph 700 mapped to that character (but preferably illustrating a different character), the text from the original text file 107 is graphically displayed even though the original text file 107 was never transmitted to the browser 102.

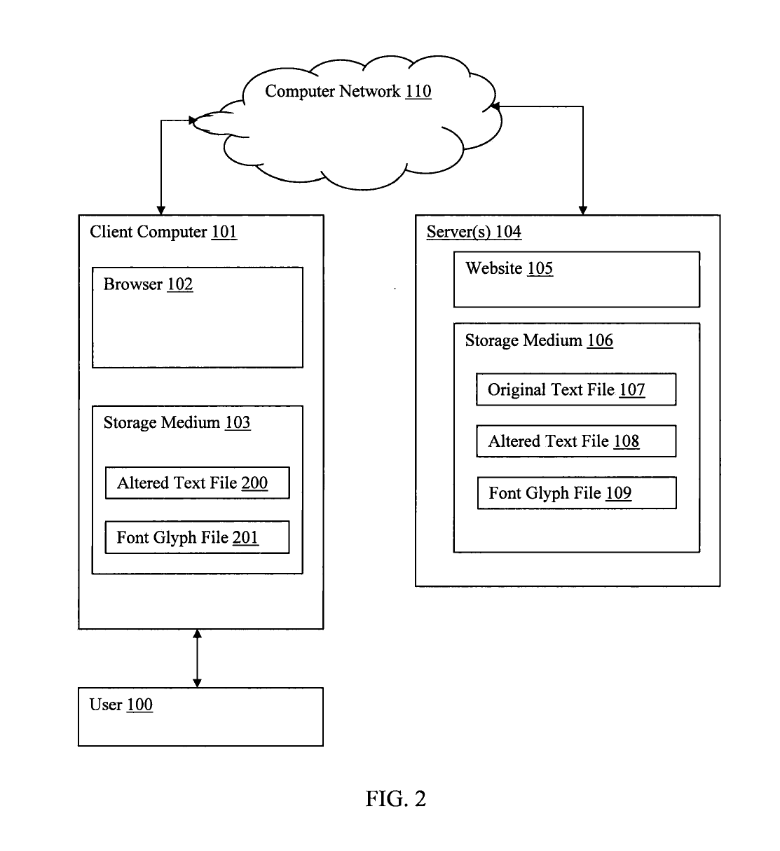

The altered text file 108 and the font glyph file 109 may be transmitted over the Internet 110 to the browser 102 running on the client computer 101. FIG. 2 shows a copy of the altered text file 200 and a copy of the font glyph file 201 stored in a storage medium 103 on the client computer 101. The browser 102 may create a graphical image 300 of the original text file 107 by replacing each character in the altered text file 200 with a font glyph 700 mapped to the character, where the font glyph 700 may graphical display a different character than the character mapped to the font glyph 700.

FIG. 8 shows the image 300 being displayed by the browser 102, running on the client computer 101, to the user 100. In this way, the browser 102 may display a graphical image 300 of the original text file 107, that matches character for character, without the browser 102 ever receiving the original text file 107, thereby making it more difficult to plagiarize the content of the website 105.

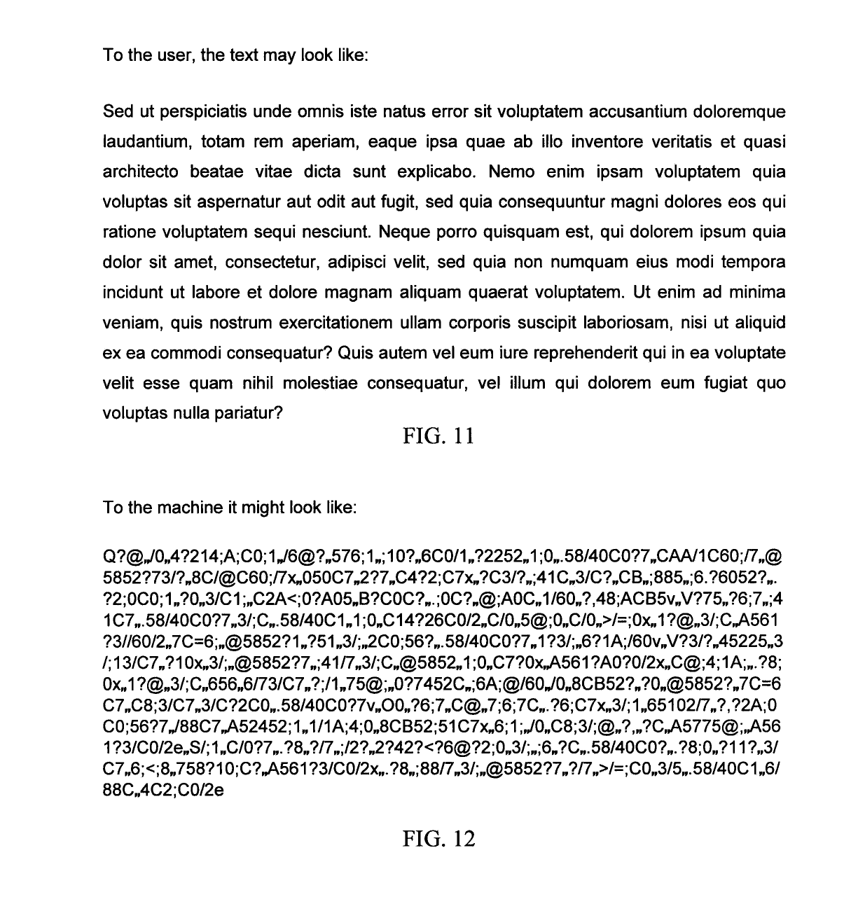

Another example is illustrated by FIG. 11 and FIG. 12. FIG. 12 represents an example text as it might exist in the original text file 107 and how this text might appear in a graphical form on a browser 102. FIG. 12 represents an example altered text file 108 based on the original text file 107 shown in FIG. 11.

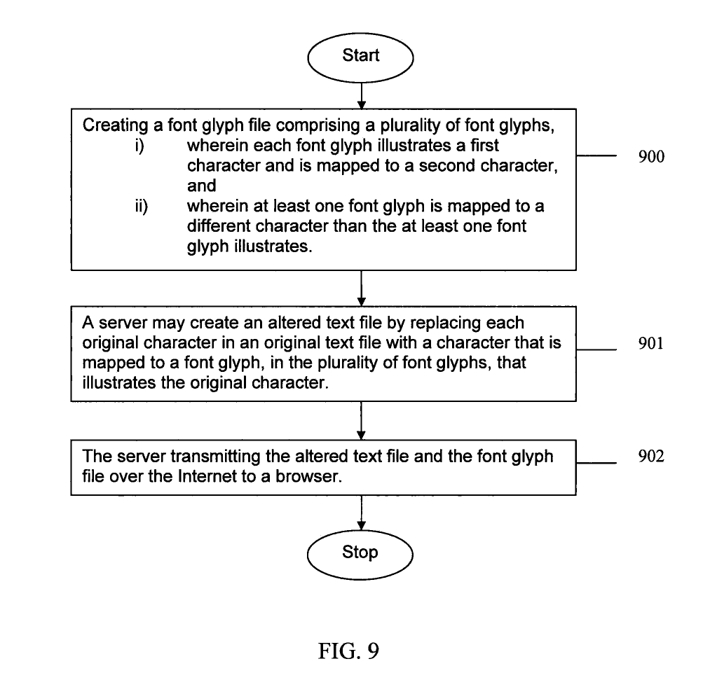

An example method for practicing the invention will now be discussed with reference to FIG. 9. This embodiment may start by an owner and/or operator of a website 105 deciding to protect a textual content of the website 105 from being plagiarized, wherein the plagiarizing would have been accomplished by copying an original text file 107. It should be noted that no protection of the textual content of a website 105 is ever going to be perfect, since the textual content will eventually be displayed/disclosed on the user's 100 client computer 101 where the textual content may be subjected to optical character recognition (OCR) or to manual copying. However, the invention does prevent plagiarizers from plagiarizing the textual content simply by copying the original text file 107.

This example method may be accomplished by creating a font glyph file 109 and an altered text file 108 in such a way that the font glyph file 109 and the altered text file 108 work together to reproduce a message from an original text file 107 on a user's 100 client computer 101. The coordination of the font glyph file 109 and the altered test file 108 may be expressed by a mapping scheme 500, such as the one described in FIG. 5, although those of ordinary skill in the art will recognize that different mapping schemes or other forms of encryption may also be used.

The font glyph file 109, such as the one shown in FIG. 7, may be created as part of the method for practicing the embodiment of the invention illustrated in FIG. 9. While the font glyph file 109 in FIG. 7 only shows capital alpha characters and the punctuation symbol “!” (for simplicity in explaining the invention), any number of different characters (which includes upper and lower case letters, numbers and symbols), from any number of different languages and/or mathematics, may be used. Preferably, at a minimum, a font glyph 700 exists in the font glyph file 109 for every character that is desired to be displayed as part of the website 105. Each font glyph 700 (which may be used to graphically display a first character on a user's 100 browser 102) may be mapped to a second character as shown in FIG. 7. Plagiarism may be prevented by mapping some or all of the font glyphs 700 in the font glyph file 109 to a different character than the character actually displayed by the font glyph 700. Thus, a font glyph 700 that has graphical data to represent an “A” may be mapped to a different character, such as the character “B.” (Step 900)

The altered text file 108, such as the one shown in FIG. 6, may be created as part of the method for practicing the embodiment of the invention illustrated in FIG. 9. The altered text file 108 may be created by replacing each original character in the original text file 107 (as shown in FIG. 4) with a character that is mapped to a font glyph 700, that illustrates the original character. (Step 901) As an example, the original text file 107 may include the character “A.” The font glyph file 109 may include a font glyph 700 that illustrates an “A,” but at the same time be mapped to a “B,” i.e., each font glyph 700 may illustrate a first character while being mapped to a second character. In this case, ever letter “A” in the original text file 107 would be replaced with the character “B,” and so on, to thereby create the altered text file 108.

The server(s) 104 may then transmit over the Internet the font glyph file 109 and the altered font glyph file 108, but preferably not the original text file 107, to one or more client computers 101. (Step 902)

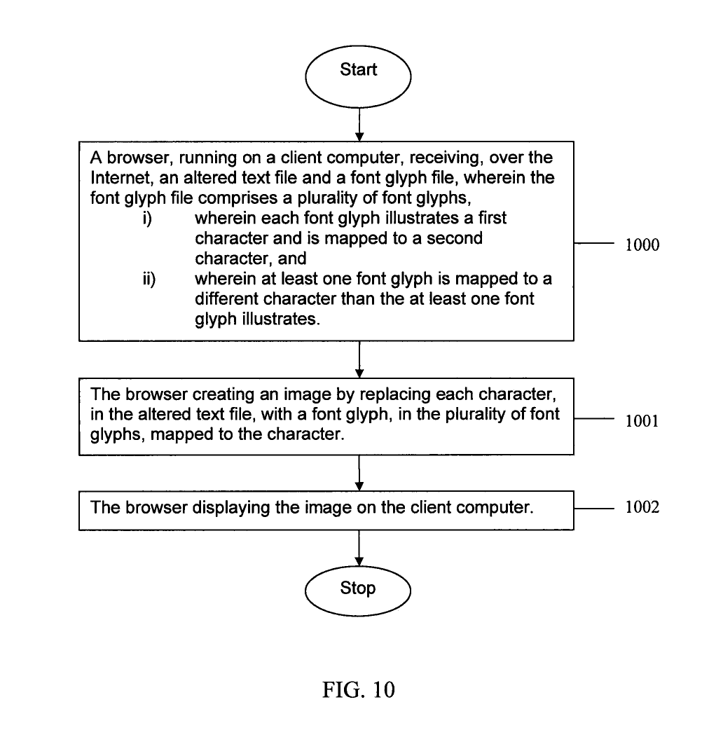

Another example for practicing the invention will now be discussed with reference to FIG. 10. In this embodiment a browser 102 may receive, over the Internet, the font glyph file 109 and the altered text file 108 created as explained above. Specifically, the font glyph file 109 may include a plurality of font glyphs 700 wherein each font glyph 700 may be used by the browser 102 to illustrate a first character while being mapped to a second character and wherein the first character may be different from the second character. In a preferred embodiment, one or more font glyphs illustrate different characters then the character the font glyphs 700 are mapped to. (Step 1000)

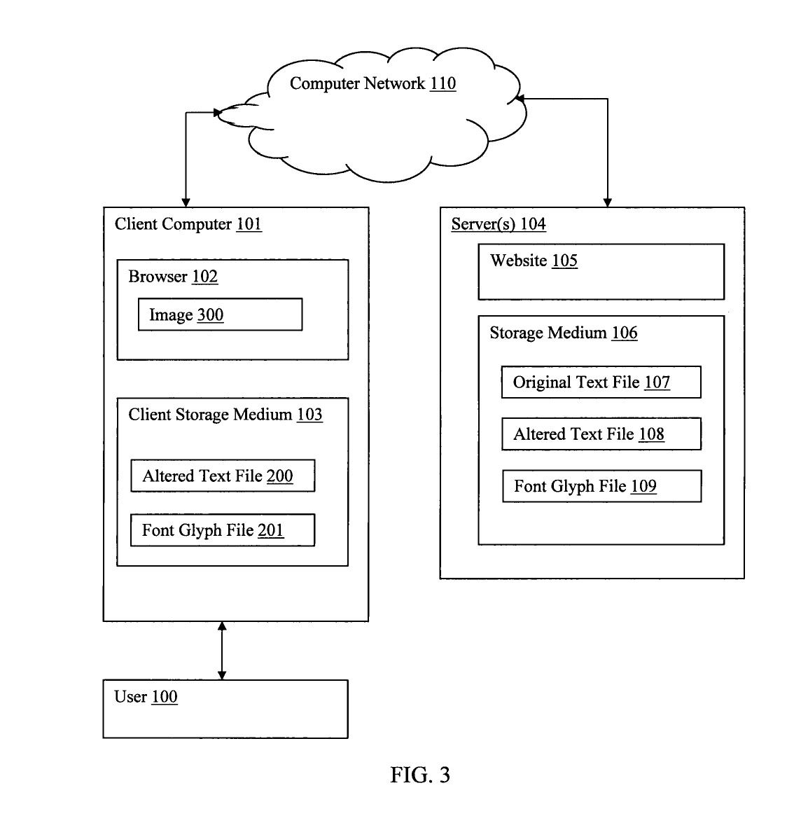

The browser 102 may create an image 300 to display (as shown in FIG. 3) by replacing each character, in the altered text file 108, with a font glyph 700 mapped to the character. This step reverses the mapping that was used to create the altered text file 108 from the original text file 107. As a specific example, the original text file 108 may have included an “A.” That “A” may have been replaced by a “B” in the altered text file 108. The browser may now take the “B” in the altered text file 108 and replace it with a font glyph 700 that, while mapped to a “B”, actually illustrates an “A.” By this process, the message in the original text 107 may be recreated and displayed on the client computer 101 without the original text file 107 ever being transmitted to the client computer 101.

The browser 102 may then display the image 300 created from the altered text file 108 and the font glyph file 109 on the client computer 101. (Step 1002)

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

The invention claimed is:

1. A system, comprising:
a) a website, running on a server, in communication over the Internet with one or more browsers, running on a corresponding one or more client computers; and
b) a storage medium, running on the server, in communication with the website,
i) wherein an original text file is stored on the storage medium,
ii) wherein an altered text file is stored on the storage medium, and
iii) wherein a font glyph file is stored on the storage medium and the font glyph file comprises a plurality of font glyphs,
A) wherein each font glyph illustrates a first character and is mapped to a second character, and
B) wherein at least one font glyph is mapped to a different character than the at least one font glyph illustrates.

2. The system of claim 1, further comprising:
c) a browser, running on a client computer, configured to:
i) receive, over the Internet, the altered text file and the font glyph file,
ii) create an image by replacing each character, in the altered text file, with a font glyph, in the plurality of font glyphs, mapped to the character, and
iii) display the image on the client computer.

3. The system of claim 2, wherein the image matches, character for character, the original text file.

4. The system of claim 1, wherein the altered text file does not match, character for character, the original text file.

5. The system of claim 1, wherein the font glyph file further comprises a plurality of characters mapped, one-to-one, to the plurality of font glyphs.

6. The system of claim 1, wherein one or more font glyphs, in the plurality of font glyphs, each comprise a graphical image of a single alpha-numeric character.

7. The system of claim 1, wherein the original text file and the altered text file each comprise one or more text files.

8. A method, comprising the steps of:
a) creating a font glyph file comprising a plurality of font glyphs,
i) wherein each font glyph illustrates a first character and is mapped to a second character, and
ii) wherein at least one font glyph is mapped to a different character than the at least one font glyph illustrates;
b) a server creating an altered text file by replacing each original character in an original text file with a character that is mapped to a font glyph, in the plurality of font glyphs, that illustrates the original character; and
c) the server transmitting the altered text file and the font glyph file over the Internet to a browser running on a client computer.

9. The method of claim 8, further comprising the steps of:
d) the browser, running on the client computer, receiving, over the Internet, the altered text file and the font glyph file;
e) the browser creating an image by replacing each character, in the altered text file, with a font glyph, in the plurality of font glyphs, mapped to the character; and
f) the browser displaying the image on the client computer.

10. The method of claim 9, wherein the displayed image matches, character for character, the original text file.

11. The method of claim 8, wherein the altered text file does not match, character for character, the original text file.

12. The method of claim 8, wherein the font glyph file further comprises a plurality of characters mapped, one-to-one, to the plurality of font glyphs.

13. The method of claim 8, wherein one or more font glyphs, in the plurality of font glyphs, each comprise a graphical image of a single alpha-numeric character.

14. The method of claim 8, wherein the original text file and the altered text file comprise text files.

15. A method, comprising the steps of:
a) a browser, running on a client computer, receiving, over the Internet, an altered text file and a font glyph file, wherein the font glyph file comprises a plurality of font glyphs,
i) wherein each font glyph in the plurality of font glyphs illustrates a first character and is mapped to a second character, and
ii) wherein at least one font glyph in the plurality of font glyphs is mapped to a different character than the at least one font glyph illustrates;
b) the browser creating an image by replacing each character, in the altered text file, with a font glyph, in the plurality of font glyphs, mapped to the character; and
c) the browser displaying the image on the client computer.

16. The method of claim 15, wherein the displayed image does not match, character for character, the altered text file.

17. The method of claim 15, wherein the font glyph file further comprises a plurality of characters mapped, one-to-one, to the plurality of font glyphs.

18. The method of claim 15, wherein one or more font glyphs, in the plurality of font glyphs, each comprise a graphical image of a single alpha-numeric character.

19. The method of claim 15, wherein the altered text file comprises a text file.
